(19) United States
(12) Patent Application Publication
(10) Pub. No.: US 2014/0091250 A1
(43) Pub. Date: Apr. 3, 2014

(54) POLYURETHANE RESIN, METHOD OF MANUFACTURING THE SAME, AND ITS USAGE

(71) Applicant: FUJIFILM Corporation, Tokyo (JP)

(72) Inventor: Kazufumi OMURA, Minami-ashigara-shi (JP)

(73) Assignee: FUJIFILM Corporation, Tokyo (JP)

(21) Appl. No.: 14/038,945

(22) Filed: Sep. 27, 2013

(30) Foreign Application Priority Data
Sep. 28, 2012 (JP) 2012-216991
Dec. 28, 2012 (JP) 2012-287661

(51) Int. Cl. H01F 1/01; C09D 175/14; C08G 18/87

(52) U.S. Cl. CPC H01F 1/01; C08G 18/87; C09D 175/14
USPC 252/62.54; 525/450; 524/590

(57) ABSTRACT

The method of manufacturing a polyurethane resin includes subjecting a (meth)acryloyl(oxy) group-containing polyurethane resin and a hydroxyl group-containing thiol to a Michael addition reaction in a solvent to provide a hydroxyl group-containing polyurethane resin.

### CROSS-REFERENCE TO RELATED APPLICATIONS

This application claims the benefit of priority under 35 USC 119 to Japanese Patent Application No. 2012-216991 filed on Sep. 28, 2012 and Japanese Patent Application No. 2012-287661 filed on Dec. 28, 2012, which are expressly incorporated herein by reference in their entirety.

### BACKGROUND OF THE INVENTION

1. Field of the Invention

The present invention relates to a method of manufacturing a polyurethane resin, and more particularly, to a method of manufacturing a polyurethane resin yielding a polyurethane resin in which hydroxyl groups have been introduced into the polyurethane main backbone.

The present invention further relates to a polyurethane resin provided by the above manufacturing method; a particulate magnetic recording medium having a layer containing the above polyurethane resin and/or a reaction product thereof; a coating-forming composition containing the above polyurethane resin; and a polyurethane coating film obtained using the above coating-forming composition.

2. Discussion of the Background

Polyurethane resin can be obtained by the urethane reaction of a difunctional or higher starting material alcohol and a difunctional or higher starting material isocyanate. When the polyurethane resin thus obtained contains hydroxyl groups, it can be mixed with an isocyanate curing agent and subjected to a curing treatment to form a coating film in which isocyanate groups have undergone a crosslinking reaction with hydroxyl groups.

In the above coating film, the more hydroxyl groups that are contained in the polyurethane resin, the greater the crosslinking density and the stronger the coating film becomes. However, since the hydroxyl groups that are contained in the starting material alcohol are consumed in the urethane reaction with the starting material isocyanate, it is usually difficult to obtain a polyurethane resin containing numerous hydroxyl groups. Accordingly, investigation has been conducted into raising the hydroxyl group content of polyurethane resin.

As examples of methods of raising the hydroxyl group content of polyurethane resin, there is the method of increasing the relative hydroxyl group content in the resin by lowering the molecular weight of the polyurethane resin, and the method of introducing branched hydroxyl groups onto the ends of the polyurethane resin by using polyhydric hydroxyl group-containing compounds as starting materials (for example, see Japanese Unexamined Patent Publication (KOKAI) No. 2001-176051, which is expressly incorporated herein by reference in its entirety).

Of the above methods, the former presents the concern of diminished polymer strength due to the decrease in molecular weight. The latter presents a problem in that a homogeneous polymer cannot be achieved because hydroxyl groups are only introduced to a specific part (the end). Were it somehow possible to introduce hydroxyl groups to the main backbone of polyurethane, it would be possible to obtain a homogeneous polyurethane resin comprising hydroxyl groups.

### SUMMARY OF THE INVENTION

An aspect of the present invention provides for a method for obtaining a polyurethane resin containing hydroxyl groups, and more particularly, to provide a method for obtaining a polyurethane resin in which hydroxyl groups have been introduced into the main backbone of polyurethane.

The present inventor conducted extensive research into achieving the above-stated method. As a result, they discovered that the above polyurethane resin could be obtained by means of a Michael addition reaction of a polyurethane resin having a (meth)acryloyl(oxy) group and a hydroxyl group-containing thiol.

The above reaction can add a hydroxyl group to the moiety on the (meth)acryloyl(oxy) group of polyurethane resin. Thus, it becomes possible to introduce a hydroxyl group into the main backbone, not onto the ends, by using a polyurethane resin having a (meth)acryloyl(oxy) group in a polyurethane main backbone. In addition, since it is possible to control the number of hydroxyl groups introduced by means of the content of (meth)acryloyl(oxy) groups of the polyurethane resin, it is possible to increase the hydroxyl group content without lowering the molecular weight.

An aspect of the present invention relates to a method of manufacturing a polyurethane resin, which comprises subjecting a (meth)acryloyl(oxy) group-containing polyurethane resin and a hydroxyl group-containing thiol to a Michael addition reaction in a solvent to provide a hydroxyl group-containing polyurethane resin.

In an embodiment, the Michael addition reaction is conducted in a solvent which comprises a base.

In an embodiment, the above method further comprises adding an equivalent or greater quantity of an acid to the base following the Michael addition reaction.

In an embodiment, the acid is an organic acid.

In an embodiment, the base is an organic base.

In an embodiment, the (meth)acryloyl(oxy) group-containing polyurethane resin comprises at least one substituent selected from the group consisting of a sulfonic acid group and a sulfonate group. Hereinafter, a sulfonic acid (salt) group means either or both a sulfonic acid group and a sulfonate group

In an embodiment, the (meth)acryloyl(oxy) group-containing polyurethane resin is polyurethane resin that has been provided through an urethane reaction with a polyol component in the form of a (meth)acryloyl(oxy) group-containing diol.

In an embodiment, the hydroxyl group-containing polyurethane resin that has been provided has a hydroxyl group equivalent specified in equation (1) below ranging from 5 to 200:

hydroxyl group equivalent=hydroxyl group value [millimole/kg]×weight average molecular weight Mw/1,000,000 (1).

In an embodiment, the solvent comprises equal to or more than 60 weight percent of a ketone solvent.

A further aspect of the present invention relates to a polyurethane resin provided by the above method.

Polyurethane resin is a resin that is widely employed as a binder resin in particulate magnetic recording media. Accordingly, the polyurethane resin according to an aspect of the present invention set forth above can be employed as a binder resin in particulate magnetic recording media. Additionally, the above polyurethane resin is a resin that can form high-strength coating films. Thus, it is suitable as the binder resin of a particulate magnetic recording medium that is required to have a coating film of good durability.

A still further aspect of the present invention relates to a particulate magnetic recording medium, which comprises a layer comprising the above polyurethane resin.

In an embodiment, the reaction product is a reaction product of a curing reaction of the polyurethane resin and a polyisocyanate.

In an embodiment, the polyisocyanate is a polyisocyanate comprising a cyclic structure.

In an embodiment, the layer is a magnetic layer comprising a ferromagnetic powder.

A further aspect of the present invention relates to a coating-forming composition, which comprising the above polyurethane resin and a polyisocyanate.

In an embodiment, the polyisocyanate is a polyisocyanate comprising a cyclic structure.

A still further aspect of the present invention relates to a polyurethane coating film, which has been formed by subjecting the above coating-forming composition to a curing treatment.

An aspect of the present invention makes it possible to obtain a resin containing a desired content of hydroxyl groups at desired positions, and makes it possible to obtain a polyurethane resin in which numerous hydroxyl groups have been introduced to the polyurethane main backbone.

By employing the above polyurethane resin as a binder resin, it is possible to provide a particulate magnetic recording medium having a high-strength coating film.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

Polyurethane Resin and Method of Manufacturing the same

The method of manufacturing a polyurethane resin according to an aspect of the present invention yields a hydroxyl group-containing polyurethane resin by subjecting a (meth)acryloyl(oxy) group-containing polyurethane resin (also referred to as a “starting material polyurethane resin”, hereinafter) with a hydroxyl group-containing thiol in a solvent.

A further aspect of the present invention provides a polyurethane resin obtained by the above manufacturing method.

The “Michael addition reaction” refers to a reaction effecting the 1,4-addition of a nucleophilic agent to an α, β-unsaturated carbonyl compound. The description below is given for the example where a polyurethane resin having a methacryloyloxy group is employed as the starting material polyurethane resin.

In the reaction formula below, the wavy line denotes the main backbone of polyurethane, and X denotes a hydroxyl group-containing group.

In one embodiment of the Michael addition reaction, the proton of a thiol denoted by X—SH is removed (deprotonation), producing an anion denoted by X—S⁻. To produce the anion, it is desirable to conduct the Michael addition reaction in a solvent containing a base. That is because the base contained in the solvent causes deprotonation, producing the anion denoted by X—S⁻. The anion that is produced functions as a nucleophilic agent, affecting the 1,4-addition to the methacryloyloxy group contained in the polyurethane resin indicated in the upper segment of the following formula. Thus, as shown in the lower segment of the following reaction formula, a hydroxyl group (hydroxyl group-containing group X) can be added to the main backbone of polyurethane.

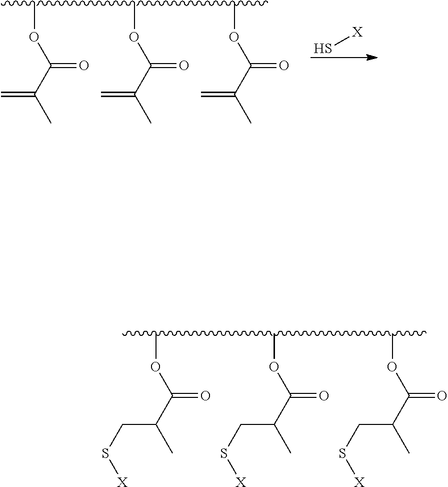

The Michael addition reaction in the present invention is not limited to being conducted in the presence of a base. From the perspective of obtaining the target hydroxyl group-containing polyurethane at high yield, it is desirable to conduct the Michael addition reaction in the presence of a base. However, instead of a base, it is possible to conduct the Michael addition reaction using a catalyst the use of which is known in the Michael addition reaction.

Based on the above Michael addition reaction, it is possible to introduce a hydroxyl group at the position of a (meth)acryloyl(oxy) group. Thus, hydroxyl groups can be introduced to the main backbone, not just to the ends of the polyurethane resin. Further, it is possible to introduce a desired quantity of hydroxyl groups to a polyurethane resin by using a quantity of thiols capable of reacting with (meta)acryloyl(oxy) groups that is suitable for a starting material polyurethane resin into which a large number of (meth)acryloyl(oxy) groups have been introduced.

The polyurethane resin and the method of manufacturing the same according to an aspect of the present invention will be described in greater detail below.

The polyurethane resin that is subjected with a thiol to the Michael addition reaction comprises a (meth)acryloyl(oxy) group. In the present invention, the term “(meth)acryloyl(oxy) group” is used to mean including an acryloyl group, methacryloyl group, acryloyloxy group, or methacryloyloxy group. The deprotonated thiol undergoes 1,4-addition to the (meth)acryloyl(oxy) group to obtain a polyurethane resin in which a hydroxyl group has been incorporated to the moiety on the (meth)acryloyl(oxy) group.

A starting material polyurethane resin in the form of a commercially available radiation-curable polyurethane resin that is generally used can be employed. It can also be synthesized by known methods. For details regarding polyrethane resins that can be employed as starting material polyurethane resins and methods of synthesizing them, reference can be made to paragraphs [0015] to [0079] and the description of Examples in Japanese Unexamined Patent Publication (KOKAI) No. 2009-96798, which is expressly incorporated herein by reference in its entirety, for example. Using a (meth)acryloyl(oxy) group-containing diol as the urethane reaction polyol component makes it possible to obtain a polyurethane resin having a (meth)acryloyl(oxy) group in the main backbone instead of on the end, or in addition to on the end, of the polyurethane. By controlling the quantity of the diol employed, it becomes possible to obtain a polyurethane resin having a desired quantity of (meth)acryloyl(oxy) groups. It is possible to obtain a polyurethane resin containing a desired number of hydroxyl groups by adding the deprotonated product of a thiol to the (meth)acryloyl(oxy) group.

Polyurethane resin is widely employed as a binder in particulate magnetic recording media. However, it is desirable to introduce adsorptive functional groups that are capable of adsorbing to powders such as ferromagnetic powders and nonmagnetic powders into the polyurethane resins that are employed as such binders. That is because the aggregation of powders can be suppressed and their dispersion can be enhanced by adsorbing adsorptive functional groups to the surface of powders.

Examples of these adsorptive functional groups are sulfonic acid (salt) groups, carboxylic acid (salt) groups, and phosphoric acid (salt) groups. The term sulfonic acid (salt) groups is employed with a meaning that includes the sulfonic acid group (—SO₃H), and sulfonate groups such as the SO₃Na group, the SO₃K group, and the SO₃Li group. The same applies to carboxylic acid (salt) groups and phosphoric acid (salt) groups. For example, polyurethane resin having sulfonic acid (salt) groups together with hydroxyl groups can be obtained by using polyurethane resin containing sulfonic acid (salt) groups that has been obtained by using the sulfonic acid (salt) group-containing diol described in Japanese Unexamined Patent Publication (KOKAI) No. 2009-967908, which is expressly incorporated herein by reference in its entirety, as a starting material polyurethane resin. The content of the sulfonic acid (salt) group in the polyurethane resin that is employed as a binder in magnetic recording media is desirably 1×10⁻⁵ eq/g to 2×10⁻³ eq/g, preferably 1×10⁻⁵ eq/g to 1×10⁻³ eq/g, and more preferably, 1×10⁻⁵ eq/g to 5×10⁻⁴ eq/g from the perspective of enhancing powder dispersion and ensuring the solubility in solvent of the polyurethane resin.

The thiol that is subjected to a Michael addition reaction with the above starting material polyurethane resin can be any compound having a hydroxyl group and a thiol group. The thiol contains at least one hydroxyl group, and can contain two or more. The more hydroxyl groups that are contained in the thiol, the more hydroxyl groups that can be incorporated into the polyurethane resin. Thus, it is desirable to employ a thiol compound containing two or more hydroxyl groups per molecule. The linking group which links the thiol and the hydroxyl group can be a linear or branched hydrocarbon group, such as a linear or branched alkyl group. Specific examples of thiols that can be employed are α-thioglycerol, 2-mercaptoethanol, 3-mercapto-1-propanol, 4-mercapto-1-butanol, 6-mercapto-1-hexanol, 7-mercapto-1-heptanol, 2,3-dimercapto-1-propanol, dithiothreitol, mercaptoborneol, mercaptoisoborneol, 3-amino-4-mercapto-1-butanol, 5-thio-D-glucose, cysteinol, 2-hydroxyethyl 3-mercaptopropionate, and 2-hydroxy-3-mercaptopropyl butyl ether.

Since thiols having two or more thiol groups sometimes gel when undergoing a Michael addition reaction, it is preferable for only one thiol group to be present per molecule of thiol. Examples of thiols that are desirable from this perspective are α-thioglycerol, 2-mercaptoethanol, 3-mercapto-1-propanol, 4-mercapto-1-butanol, 6-mercapto-1-hexanol, 7-mercapto-1-heptanol, mercaptoborneol, mercaptoisoborneol, 3-amino-4-mercapto-1-butanol, 5-thio-D-glucose, cysteinol, 2-hydroxyethyl 3-mercaptopropionate, and 2-hydroxy-3-mercaptopropyl butyl ether.

The polyurethane resin obtained following the Michael addition reaction can be employed in combination with polyisocyanate as set forth further below to form a crosslinked structure and to form a high-strength coating film. To achieve effective crosslinking with a polyisocyanate, at least one of the hydroxyl groups contained in the thiol is desirably an alcohol hydroxyl group, with a primary hydroxyl or secondary hydroxyl group being preferred.

The above-described starting material polyurethane resin and hydroxyl group-containing thiol can be added to a solvent and mixed to induce a Michael addition reaction. As set forth above, when a solvent containing a base is employed, the base deprotonates the thiol and causes the Michael addition reaction to proceed smoothly. Either an organic or inorganic base can be employed. From the perspective of solubility in solvent, the use of an organic base is desirable. Examples of organic bases that can be employed are 1,8-diazabicyclo[5.4.0]undeca-7-ene (DBU), triethylamine, tripropylamine, tributylamine, triamylamine, trihexylamine, trioctylamine, pyridine, and picoline. To speed up the reaction, it is desirable to employ a strong base. It is desirable to employ a base with a base strength pKb falling within a range of 6.50 to 13.0. In the present invention, the term “base strength” refers to a value that is measured by the following method.

A 50 mg sample is dissolved in a mixed solution of 20 mL of water and 30 mL of tetrahydrofuran. Using a GT-100Win automatic titrator made by Mitsubishi Chemicals Analytech, 0.1 N-HCl (Wako Pure Chemical Industries, Ltd.) is added dropwise to conduct neutralization titration. The pH corresponding to one half of the quantity that has been added dropwise when the neutral point is reached is read. That pH is adopted as the base strength (pKb). The use of a quantity of base adequate to deprotonate the thiol suffices. For example, about 0.001 to 100 weight parts per 100 weight parts of thiol can be employed.

It suffices to select an organic solvent for use that can exhibit a good ability to dissolve the thiol employed. For example, the following can be employed in any ratio: ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methyl cyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorhydrin, and dichlorobenzene; N,N-dimethyl formamide; and hexane. Thiol compounds normally dissolve well in ketone solvents. It is thus desirable to employ a solvent containing equal to or more than 60 weigh percent of a ketone solvent relative to the total solvent. A 100 percent ketone solvent can also be employed. When the reaction solution is employed as is following the Michael addition reaction, or when another component such as a curing agent is added to form a coating film, a volatile solvent with a relatively low boiling point is desirable. The ketone solvents are also desirable from this perspective.

The quantity of starting material polyurethane resin in the solvent can be, for example, 1 to 40 weight parts per 100 weight parts of solvent. Additionally, the (meth)acryloyl(oxy) groups that are contained in the starting material polyurethane resin are desirably present in a quantity such that the hydroxyl group equivalent, described further below, following the reaction with the thiol is equal to or greater than 5, preferably such that the hydroxyl group equivalent falls within a range of 5 to 200. This is because the polyurethane resin containing hydroxyl groups in the above hydroxyl group equivalent can form a crosslinked structure of high crosslinking density with the polyisocyanate, making it possible to form a high-strength coating film. In that case, the quantity of thiol can be, in molar basis, greater than, equal to, or less than the (meth)acryloyl(oxy) groups contained in the starting material polyurethane. The reaction conditions commonly employed in a Michael addition reaction can be applied. For example, the reaction temperature can be 20 to 90° C., the reaction period can be 10 minutes to 10 hours, and the reaction can be conducted at atmospheric pressure.

A polyurethane resin into which thiol-derived hydroxyl groups have been incorporated can be obtained by the above-described Michael addition reaction. An aspect of the present invention makes it possible to introduce hydroxyl groups as substituents into the main backbone in addition to adding them on the ends, or while not adding them to the ends, of the polyurethane. The more (meth)acryloyl(oxy) groups that are contained in the starting material polyurethane resin, the more hydroxyl groups will be incorporated into the polyurethane resin that is obtained. An aspect of the present invention makes it possible to obtain a polyurethane resin containing 5 or more hydroxyl group equivalents as specified by equation (1) below, for example, desirably falling within a range of 5 to 200. This hydroxyl group equivalent is a value that is difficult to achieve by the method of reducing the molecular weight of the polyurethane resin to correspondingly raise the hydroxyl group content of the resin.

Hydroxyl group equivalent=hydroxyl group value [millimole/kg]×weight average molecular weight Mw/1,000,000 (1)

Further, the method of raising the hydroxyl group content by introducing terminal and branch hydroxyl groups localizes the hydroxyl groups on the ends, making it difficult to obtain a homogeneous polymer. By contrast, according to an aspect of the present invention, the positions at which the hydroxyl groups are incorporated correspond to the positions of the (meth)acryloyl(oxy) groups in the starting material polyurethane resin. Thus, the (meth)acryloyl(oxy) groups of the starting material polyurethane resin can be introduced as substituents onto the polyurethane main backbone, thereby making it possible to obtain a homogeneous polymer in which hydroxyl groups have been introduced onto the polyurethane main backbone.

A polyurethane resin into which hydroxyl groups have been incorporated can be obtained by the above steps.

### Particulate Magnetic Recording Medium

A further aspect of the present invention relates to a particulate magnetic recording medium comprising a layer containing the polyurethane resin according to an aspect of the present invention and/or a reaction product thereof.

Polyurethane resin is widely employed as a binder resin in particulate magnetic recording media. Accordingly, the polyurethane resin according to an aspect of the present invention can also be used as a binder resin to manufacture a particulate magnetic recording medium.

Further, in the polyurethane resin according to an aspect of the present invention, hydroxyl groups are introduced by the Michael addition reaction. The hydroxyl groups can form a crosslinked structure by undergoing a urethane reaction (curing reaction) with polyisocyanate. Accordingly, after coating, either directly or indirectly through another layer, a coating composition containing the polyurethane resin according to an aspect of the present invention and a polyisocyanate on a nonmagnetic support, and causing the hydroxyl groups contained in the polyurethane resin and the isocyanate groups contained in the isocyanate to undergo a curing reaction (heat treatment or the like) to effect a urethane reaction, it is possible to faun a layer imparted with high strength by means of a crosslinked structure on the nonmagnetic support. The layer that is thus formed contains the reaction product of the curing reaction of the hydroxyl group-containing polyurethane resin according to an aspect of the present invention and the polyisocyanate, and may become a layer into which any unreacted polyurethane resin can be incorporated.

Difunctional and higher isocyanate compounds can be employed as the above polyisocyanate. For example, difunctional and higher polyisocyanates such as tolylene diisocyanate, 4,4′-diphenylmethane diisocyanate, hexamethylene diisocyanate, xylylene diisocyanate, napthylene-1,5-diisocyanate, o-toluidene diisocyanate, isophorone diisocyanate, triphenylmethane triisocyanate, and other isocyanates; products of these isocyanates and polyalcohols; and polyisocyanates produced by the condensation of isocyanates can be employed. These can be synthesized by known methods, and are available as commercial products. From the perspective of increasing coating strength, the use of a trifunctional or higher polyisocyanate is desirable. Specific examples of trifunctional and higher polyisocyanates are the compound obtained by adding 3 moles of tolylene diisocyanate (TDI) to trimethylol propane (TMP), the compound obtained by adding 3 moles of hexamethylene diisocyanate (HDI) to TMP, the compound obtained by adding 3 moll of isophorone diisocyanate (IPDI) to TMP, the compound obtained by adding 3 moles of xylene diisocyanate (XDI) to TMP, and other adduct polyisocyanate compounds; condensed isocyanurate trimers of TDI, condensed isocyanurate pentamers of TDI, condensed isocyanurate heptamers of TDI, and mixtures thereof. Further examples are isocyanurate condensates of HDI, iscyanurate condensates of IPDI, and crude MDI. From the perspective of the strength of the coating film that is formed, an example of a polyisocyanate that is desirably employed in combination with the hydroxyl group-containing polyurethane resin of the present invention is a polyisocyanate having a cyclic structure. The cyclic structure that is contained can be a nonaromatic saturated or unsaturated carbon ring or hetero ring, or an aromatic carbon ring or hetero ring. The quantity of curing agent employed can be, for example, 5 to 80 weight parts per 100 weight parts of the above polyurethane resin.

The base can exhibit a catalytic action in the reaction system of the urethane reaction (crosslinking reaction) of hydroxyl groups and isocyanate groups. Thus, when employing a base in the above Michael addition reaction, when the curing treatment is conducted with a large quantity of residual base present, the crosslinking reaction ends up progressing extremely rapidly. This can sometimes make it difficult to form a film and compromises the homogeneity of the coating film obtained. To prevent the occurrence of such phenomena, it is desirable to add an acid following the conclusion of the Michael addition reaction. To get the crosslinking reaction of the polyurethane resin and the polyisocyanate to proceed smoothly, it is desirable to add an acid to convert part or all of the base into a weakly basic corresponding salt. A quantity that is approximately equivalent to that of the base employed in the Michael addition reaction is desirably added. When a strong base is neutralized with a weak acid, the salt obtained will exhibit weak basicity. Thus, a slight excess of acid can be added.

The above acid is not specifically limited other than that it be capable of neutralizing the base. Either an organic or inorganic acid can be selected for use. Examples of inorganic acids are hydrochloric acid, sulfuric acid, phosphoric acid, and phosphorous acid. Examples of organic acids are acetic acid, propionic acid, butanoic acid, pentanoic acid, hexanoic acid, heptanoic acid, octanoic acid, 2-ethylhexanoic acid, oxalic acid, and succinic acid. From the perspective of solubility in solvent, the use of an organic acid is desirable.

In the particulate magnetic recording medium according to an aspect of the present invention, the layer containing the polyurethane resin according to an aspect of the present invention and/or a reaction product thereof can be a magnetic layer, nonmagnetic layer, or backcoat layer. For example, providing the above layer as a magnetic layer makes it possible to provide a particulate magnetic recording medium that is suitable as a backup tape with high durability capable of withstanding long-term contact and sliding of the magnetic head against the magnetic layer. In one embodiment the polyurethane resin according to an aspect of the present invention can be recovered by known methods from the reaction solution following the Michael addition reaction and employed as a binder resin. Further, in one embodiment that is desirable from the perspective of convenience, the polyurethane resin according to an aspect of the present invention can be left in the reaction solution following the Michael addition reaction and components for forming a target layer, and additional solvent as needed, can be added to the reaction solution to prepare a coating composition. This composition can then be used to form various layers such as the magnetic layer.

In addition to having the above-described layers, the particulate magnetic recording medium according to an aspect of the present invention can be applied without limitation to known techniques relating to particulate magnetic recording media. For example, reference can be made to Japanese Unexamined Patent Publication (KOKAI) No. 2011-216179, which is expressly incorporated herein by reference in its entirety, paragraphs [0018] to [0027] for the magnetic layer; paragraphs [0028] to [0176] for the nonmagnetic layer; and paragraphs [0177] to and the description in Examples for details regarding the nonmagnetic support, layer structure, manufacturing method, and the like.

Coating-Forming Composition and the Polyurethane Coating Formed Using the same

A further aspect of the present invention relates to a coating-forming composition containing the polyurethane resin according to an aspect of the present invention and a polyisocyanate.

A still further aspect of the present invention provides a polyurethane coating film formed by subjecting the above coating-forming composition to a curing treatment.

In the polyurethane resin according to an aspect of the present invention, hydroxyl groups are introduced by the Michael addition reaction. The hydroxyl groups can form a crosslinked structure by means of a urethane reaction with a polyisocyanate. Accordingly, it is possible to subject a coating-forming composition, obtained by mixing the polyurethane resin according to an aspect of the present invention with a polyisocyanate, to a curing treatment to obtain a coating that is imparted with high strength by a crosslinked structure.

Components such as known additives can be optionally added to the coating-forming composition based on solvent and coating applications. Reference can be made to the description set forth above for details regarding solvents.

The polyurethane coating film according to an aspect of the present invention is normally formed by coating the above coating composition on a support and then subjecting it to a curing treatment. The curing treatment is usually conducted by heating. Known conditions can be adopted in the curing treatment.

The more uniformly the hydroxyl groups are incorporated into the polyurethane resin that reacts with the polyisocyanate without becoming localized, the more uniform the crosslinked structure that is formed in the coating film. An aspect of the present invention makes it possible to incorporate hydroxyl groups into the main backbone without localizing hydroxyl groups on the ends of the polyurethane. Thus, an aspect of the present invention makes it possible to form a polyurethane coating film with a uniform crosslinked structure. One embodiment of the polyurethane coating film is a layer such as a magnetic layer included in the particulate magnetic recording medium according to an aspect of the present invention set forth above.

### EXAMPLES

The present invention will be further described through Examples below. However, the present invention is not limited to the embodiments shown in Examples. A 400 MHz NMR (AVANCEII-400 made by Bruker) was employed in the ¹H-NMR measurements below.

Methacryloyloxy group-containing polyurethane resin is referred to as type A polyurethane, and polyurethane resin obtained by incorporating hydroxyl groups into type A polyurethane by the Michael addition reaction is referred to as type B polyurethane below.

The hydroxyl group equivalent indicated below is a value calculated by the following method.

Polyurethane solution was weighed out in a three-necked flask so as to contain one weight part of the solid fraction of polyurethane. To this were added 0.25 weight part of acetic anhydride and 4.75 weight parts of pyridine and the mixture was reacted for 1 hour at 50° C. Subsequently, 10 weight parts of ion-exchange water were added, the mixture was stirred for 10 minutes, and 10 weight parts of 2-butanol were added. The solution obtained was then titrated with 0.5N-KOH/EtOH solution to determine the titration end point.

With the exception that no polyurethane solution was weighed out, the same method was used to conduct a blank test.

The hydroxyl group value obtained from the equation below was used to calculate the hydroxyl group equivalent using equation (1) above.

Hydroxyl group value=(quantity of 0.5N-KOH/EtOH dispensed in blank test−quantity of 0.5N-KOH/EtOH dispensed for polyurethane-containing solution)×5,000

### 1. Examples Relating to Manufacturing Hydroxyl Group-Containing Polyurethane Resin by the Michael Addition Reaction

### Examples 1-1 to 1-51

### Synthesis of Sulfonate Group-Containing Diol

To 250 weight parts of water were added 100 weight parts of 2-aminoethanesulfonic acid and 44.8 weight parts of potassium hydroxide and the mixture was stirred for 30 minutes at 45° C. To this were added 213.3 weight parts of butyl glycidyl ether and the mixture was stirred for another 2 hours at 45° C. Four hundred weight parts of toluene were added and the mixture was stirred for 10 minutes. The mixture was allowed to stand and the lower layer was removed. The lower layer obtained was solidified and dried, yielding sulfonate group compound (S-1). The ¹H-NMR data assignments of (S-1) are given below.

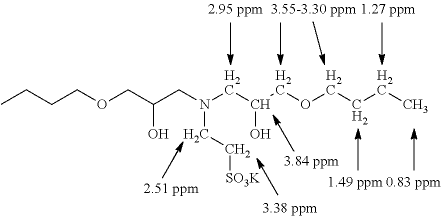

### Synthesis Example 1 of Type A Polyurethane

To 50.5 weight parts of cyclohexanone were added 1.0 weight part of sulfonate group compound (S-1), 8.7 weight parts of polyether polyol (Adeka polyether BPX-1000 made by Adeka Corp.), 7.5 weight parts of tricyclo[5,2,1,0(2,6)]decanedimethanol (made by Tokyo Chemical Industry Company, Ltd.), 1.9 weight parts of glycerine monomethacrylate (Bremmer GLM, made by NOF Corp.), 0.01 weight part of dibutyltin dilaurate, and 0.003 weight part of p-methoxyphenol (made by Wako Pure Chemical Industries, Ltd.) and the mixture was completely dissolved by stirring for 30 minutes at room temperature. The moisture content within the flask was measured with a Karl Fischer moisture meter. An equimolar quantity of diphenylmethane diisocyanate (MDI) (Millionate MT made by Nippon Polyurethane Industry Co., Ltd.) relative to the water contained was added. The internal temperature was set to 80° C., after which 15.3 weight parts of diphenylmethane diisocyanate (Millionate MT made by Nippon Polyurethane Industry Co., Ltd.) were added in installments at a rate yielding an internal temperature of 80 to 90° C. The mixture was stirred for 5 hours at an internal temperature of 80 to 90° C., after which it was cooled to room temperature. To this were added 29.5 weight parts of cyclohexanone, yielding a solution of type A polyurethane 1 (A-1).

The weight average molecular weight and weight average molecular weight/number average molecular weight ratio (Mw/Mn) of the type A polyurethane resin 1 (A-1) obtained were calculated based on standard polystyrene conversion using DMF solvent containing 0.3 weight percent of lithium bromide. The weight average molecular weight was 70,000 and Mw/Mn=1.90.

### Type A Polyurethane Synthesis Examples 2 to 12

With the exception that the various synthesis starting materials were changed as indicated in Table 1, type A polyurethanes 2 to 12 were obtained by the same method as in synthesis example 1 of type A polyurethane.

TABLE 1
(Unit: weigh part)

| | A-1 | A-2 | A-3 | A-4 | A-5 | A-6 |
|---|---|---|---|---|---|---|
| S-1 | 1.0 | 1.0 | 1.0 | 2.5 | 1.0 | |
| Polyether polyol | 8.7 | 8.7 | 9.3 | 8.7 | 4.4 | 8.7 |
| Polyester polyol 1 | | | | | 4.4 | |
| Polyester polyol 2 | | | | | | |
| Neopentyl glycol | | | | | | |
| Tricyclo | 7.5 | 7.5 | 5.0 | 4.0 | 7.5 | 4.2 |
| [5,2,1,0(2,6)]decanedimethanol | | | | | | |
| Glycerine monomethacrylate | 1.9 | 1.9 | 3.9 | | 1.9 | 2.1 |
| (Product name: Bremmer GLM, | | | | | | |
| made by NOF Corp.) | | | | | | |
| Diglycidyl bisphenol A diacrylate | | | | 5.4 | | |
| (Product name: Epoxy Ester 3000 | | | | | | |
| A, made by Kyoeisha Chemical | | | | | | |
| Co., Ltd.) | | | | | | |
| Diphenylmethane diisocyanate | 15.3 | 15.3 | 15.4 | 11.2 | 15.3 | 11.2 |
| (MDI) | | | | | | |
| Dibutyltin dilaurate | 0.01 | 0.01 | 0.01 | 0.01 | 0.01 | 0.01 |
| p-methoxyphenol | 0.003 | 0.003 | 0.003 | 0.003 | 0.003 | 0.003 |
| Weight average molecular | 70000 | 50000 | 50000 | 50000 | 70000 | 50000 |
| weight[Mw] | | | | | | |
| Hydroxyl group value[mol/t] | 29 | 40 | 40 | 40 | 29 | 40 |
| Hydroxyl group equivalent | 2 | 2 | 2 | 2 | 2 | 2 |
| | A-7 | A-8 | A-9 | A-10 | A-11 | A-12 |
| S-1 | | | | | | |
| Polyether polyol | | | | | | |
| Polyester polyol 1 | | | | | | |
| Polyester polyol 2 | 13.5 | 5.8 | 4.8 | 1.8 | 3.9 | 9.0 |
| Neopentyl glycol | | | 0.3 | | | |
| Tricyclo | | | | | | |
| [5,2,1,0(2,6)]decanedimethanol | | | | | | |
| Glycerine monomethacrylate | 1.0 | 1.0 | 1.0 | 1.0 | | 1.0 |
| (Product name: Bremmer GLM, | | | | | | |
| made by NOF Corp.) | | | | | | |
| Diglycidyl bisphenol A diacrylate | | | | | 1.0 | |
| (Product name: Epoxy Ester 3000 | | | | | | |
| A, made by Kyoeisha Chemical | | | | | | |
| Co., Ltd.) | | | | | | |
| Diphenylmethane diisocyanate | 3.1 | 2.1 | 2.8 | 1.7 | 0.9 | 2.3 |
| (MDI) | | | | | | |
| Dibutyltin dilaurate | 0.01 | 0.01 | 0.01 | 0.01 | 0.01 | 0.01 |
| p-methoxyphenol | 0.002 | 0.002 | 0.002 | 0.002 | 0.002 | 0.002 |
| Weight average molecular | 70000 | 70000 | 70000 | 70000 | 70000 | 70000 |
| weight[Mw] | | | | | | |
| Hydroxyl group value[mol/t] | 29 | 29 | 29 | 29 | 29 | 29 |
| Hydroxyl group equivalent | 2 | 2 | 2 | 2 | 2 | 2 |

Diglycidyl bisphenol A diacrylate (product name: Epoxy Ester 3000 A, made by Kyoeisha Chemical Co., Ltd.)

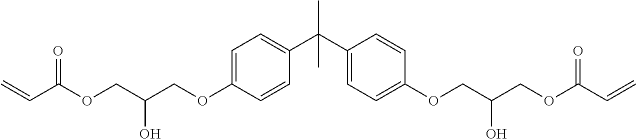 [SMILES: C=CC(=O)OCC(O)COc1ccc(C(C)(C)c2ccc(OCC(O)COC(=O)C=C)cc2)cc1]

Glycerine monomethacrylate (product name: Bremmer GLM, made by NOF Corp.)

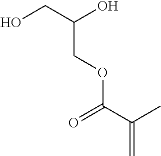

### Synthesis Example 1 of Type B Polyurethane

To 100 weight parts of a solution of the type A polyurethane (A-1) obtained in Example 1 (a cyclohexanone solution containing 30 weight percent of polyurethane A-1) were added 0.03 weight part of 1,8-diazabiscyclo[5.4.0]undeca-7-ene (DBU) made by Tokyo Chemical Industry Co., Ltd. and 1.12 weight parts of α-thioglycerol (ATG) made by Tokyo Chemical Industry Co., Ltd. and the mixture was reacted for 7 hours at 50° C. The solution obtained was cooled to room temperature and 0.03 weight part of acetic acid was added, yielding a resin solution of type B polyurethane 1 (B-1). Measurement of the residual ATG by the method set forth further below detected none. It was thus confirmed that the entire quantity of ATG had been consumed in the Michael addition reaction. The weight average molecular weight of the type B polyurethane 1 (B-1) obtained was calculated based on standard polystyrene conversion with DMF solvent containing 0.3 weight percent lithium bromide.

### Type B Polyurethane Synthesis Examples 2 to 51

With the exception that the various synthesis starting materials were changed as indicated in Table 2, type B polyurethanes B-2 to B-51 were obtained by the same method as in synthesis example 1 of type B polyurethane The type B polyurethanes obtained were evaluated in the same manner as in synthesis example 1.

When residual ATG was measured by the method set forth further below in the type B polyurethane resin solutions obtained in the synthesis examples in which α-thioglycerol (ATG) was employed as the hydroxyl group-containing thiol, none was detected. Thus, the entire quantity of ATG was confirmed to have been consumed in the Michael addition reaction.

When residual 3-mercapto-1-propanol (3MP) was measured by the method set forth further below in the type B polyurethane resin solutions obtained in the synthesis examples in which 3MP made by Tokyo Chemical Industry Co., Ltd. was employed as the hydroxyl group-containing thiol, none was detected. Thus, the entire quantity of 3MP was confirmed to have been consumed in the Michael addition reaction.

TABLE 2

| | | | | Quantity of | | Quantity of | | | |
|---|---|---|---|---|---|---|---|---|---|
| | | Quantity of | Quantity of DBU | type ATG | Quantity of | acetic acid | | Hydroxyl | Hydroxyl |
| | Type A | type A added | added | added | 3MP added | added | | group value | group |
| | polyurethane | (weight part) | (weight part) | (weight part) | (weight part) | (weight part) | Mw | [millimole/kg] | equivalent |
| B-1 | 1 | 30 | 0.03 | 1.12 | | 0.03 | 70000 | 660 | 46 |
| B-2 | 1 | 30 | 0.03 | 0.56 | | 0.03 | 70000 | 340 | 24 |
| B-3 | 1 | 30 | 0.03 | 0.28 | | 0.03 | 70000 | 170 | 12 |
| B-4 | 2 | 30 | 0.03 | 1.12 | | 0.03 | 50000 | 660 | 33 |
| B-5 | 2 | 30 | 0.03 | 0.56 | | 0.03 | 50000 | 340 | 17 |
| B-6 | 2 | 30 | 0.03 | 0.28 | | 0.03 | 50000 | 170 | 9 |
| B-7 | 3 | 30 | 0.03 | 2.26 | | 0.03 | 50000 | 1290 | 65 |
| B-8 | 3 | 30 | 0.03 | 1.12 | | 0.03 | 50000 | 660 | 33 |
| B-9 | 3 | 30 | 0.03 | 0.56 | | 0.03 | 50000 | 340 | 17 |
| B-10 | 3 | 30 | 0.03 | 0.28 | | 0.03 | 50000 | 170 | 9 |
| B-11 | 1 | 30 | 0.03 | 1.12 | | 0 | 70000 | 660 | 46 |
| B-12 | 1 | 30 | 0.03 | 0.56 | | 0 | 70000 | 340 | 24 |
| B-13 | 1 | 30 | 0.03 | 0.28 | | 0 | 70000 | 170 | 12 |
| B-14 | 2 | 30 | 0.03 | 1.12 | | 0 | 50000 | 660 | 33 |
| B-15 | 2 | 30 | 0.03 | 0.56 | | 0 | 50000 | 340 | 17 |
| B-16 | 2 | 30 | 0.03 | 0.28 | | 0 | 50000 | 170 | 9 |
| B-17 | 3 | 30 | 0.03 | 2.26 | | 0 | 50000 | 1290 | 65 |
| B-18 | 3 | 30 | 0.03 | 1.12 | | 0 | 50000 | 660 | 33 |
| B-19 | 3 | 30 | 0.03 | 0.56 | | 0 | 50000 | 340 | 17 |
| B-20 | 3 | 30 | 0.03 | 0.28 | | 0 | 50000 | 170 | 9 |
| B-21 | 6 | 30 | 0.03 | 1.12 | | 0.03 | 50000 | 660 | 33 |
| B-22 | 6 | 30 | 0.03 | 0.56 | | 0.03 | 50000 | 340 | 17 |
| B-23 | 6 | 30 | 0.03 | 0.28 | | 0.03 | 50000 | 170 | 9 |
| B-24 | 2 | 30 | 0.03 | | 1.22 | 0.03 | 50000 | 440 | 22 |
| B-25 | 6 | 30 | 0.03 | | 1.22 | 0.03 | 50000 | 420 | 21 |
| B-26 | 6 | 30 | 0.03 | | 0.61 | 0.03 | 50000 | 220 | 11 |
| B-27 | 6 | 30 | 0.03 | | 0.3 | 0.03 | 50000 | 110 | 6 |
| B-28 | 5 | 30 | 0.03 | | 0.83 | 0.03 | 70000 | 300 | 21 |
| B-29 | 5 | 30 | 0.03 | 0.56 | | 0.03 | 70000 | 340 | 24 |
| B-30 | 7 | 30 | 0.03 | 1.16 | | 0.01 | 70000 | 700 | 49 |
| B-31 | 7 | 30 | 0.03 | 0.58 | | 0.01 | 70000 | 350 | 25 |
| B-32 | 7 | 30 | 0.03 | 0.29 | | 0.01 | 70000 | 175 | 12 |
| B-33 | 8 | 30 | 0.03 | 2.32 | | 0.01 | 70000 | 1400 | 98 |
| B-34 | 8 | 30 | 0.03 | 1.16 | | 0.01 | 70000 | 700 | 49 |
| B-35 | 8 | 30 | 0.03 | 0.58 | | 0.01 | 70000 | 350 | 25 |
| B-36 | 8 | 30 | 0.03 | 0.29 | | 0.01 | 70000 | 175 | 12 |
| B-37 | 9 | 30 | 0.03 | 2.32 | | 0.01 | 70000 | 1400 | 98 |
| B-38 | 9 | 30 | 0.03 | 1.16 | | 0.01 | 70000 | 700 | 49 |
| B-39 | 9 | 30 | 0.03 | 0.58 | | 0.01 | 70000 | 350 | 25 |
| B-40 | 9 | 30 | 0.03 | 0.29 | | 0.01 | 70000 | 175 | 12 |
| B-41 | 10 | 30 | 0.03 | 4.64 | | 0.01 | 70000 | 2800 | 196 |
| B-42 | 10 | 30 | 0.03 | 2.32 | | 0.01 | 70000 | 1400 | 98 |
| B-43 | 10 | 30 | 0.03 | 1.16 | | 0.01 | 70000 | 700 | 49 |
| B-44 | 10 | 30 | 0.03 | 0.58 | | 0.01 | 70000 | 350 | 25 |
| B-45 | 10 | 30 | 0.03 | 0.29 | | 0.01 | 70000 | 175 | 12 |
| B-46 | 11 | 30 | 0.03 | 1.16 | | 0.01 | 70000 | 700 | 49 |
| B-47 | 11 | 30 | 0.03 | 0.58 | | 0.01 | 70000 | 350 | 25 |
| B-48 | 11 | 30 | 0.03 | 0.29 | | 0.01 | 70000 | 175 | 12 |
| B-49 | 12 | 30 | 0.03 | 1.66 | | 0.01 | 70000 | 1000 | 70 |
| B-50 | 4 | 30 | 0.03 | 1.16 | | 0.01 | 70000 | 700 | 49 |
| B-51 | 4 | 30 | 0.03 | 0.58 | | 0.01 | 70000 | 350 | 25 |

(Method of Confirming Residual ATG)

One weight part of polyurethane resin solution was diluted with 1,000 weight parts of acetone and a gas chromatography measurement was made under the following conditions. No ATG peak was found at 13.78 minutes.

Measurement apparatus: GC-17A made by Shimadzu

Column: DB-1 (30 m×0.25 mm×0.25 mm)

Inlet temperature: 250° C.

Detector temperature: 250° C.

Column temperature: 50° C./10 minutes→raised by 10° C./min to 100°→kept at 100° C. for 10 minutes→raised by 30° C./minute to 350° C.

(Method of Confirming Residual 3MP)

One weight part of polyurethane resin solution was diluted with 1,000 weight parts of acetone and gas chromatography was conducted under the conditions employed in the method of confirming residual ATG. No 3MP peak was found at 6.73 minutes.

### 2. Examples and Comparative Examples Relating to Polyurethane Coating Films (Comparison of Gel Fractions)

### Example 2-1

The solid fraction contained in the resin solution of polyurethane B-1 was measured by the method set forth further below. A quantity of polyurethane B-1 resin solution equivalent to 1 weight part of solid fraction was weighed out and cooled to equal to or lower than 10° C. After adding 0.30 weight part of a solution (solid fraction 0.15 weight part, toluene 0.075 weight part, methyl ethyl ketone (2-butanone) 0.075 weight part) of polyisocyanate (Coronate 3041, made by Nippon Polyurethane Industry Co., Ltd.) to the cooled solution, cyclohexanone was added to achieve a 22 weight percent solid fraction and dissolution was conducted. A coating was applied to a base film (TORELINA Film 3000, made by Toray Corp.) with a doctor blade having a 300 μm gap and vacuum drying was conducted for 30 minutes at 140° C. The dry film obtained was cooled to room temperature and annealed under conditions of 70° C. for 2 days. The annealed film obtained was cooled to room temperature and peeled off the base film, yielding a polyurethane film.

Measurement of uncrosslinked polyisocyanate by the method set forth further below detected none.

Measurement of the gel fraction by the method set forth further below revealed a gel fraction of 96 percent.

(Method of Measuring Solid Fraction Concentration)

One weight part of a resin solution of polyurethane B-1 was weighted out into an aluminum cup. A first drying cycle was conducted under conditions of 40° C./atmospheric pressure/1 hour, followed by a second drying cycle under conditions of 140° C./vacuum/3 hours. Following the second drying cycle, the aluminum cup was left standing for 30 minutes in an environment of 27° C. and 50 percent relative humidity, and then weighed on a scale.

The weight of the polyurethane remaining in the aluminum cup after drying was divided by the value of one weight part and the result was multiplied by 100 to obtain the solid fraction concentration (weight percent).

(Method of Detecting Uncrosslinked Polyisocyanate)

FT-IR measurement of the polyurethane film obtained was conducted in transmission mode with an IR Prestige-21 made by Shimadzu. No isocyanate peak was observed for uncrosslinked polyisocyanate at 2,270 cm⁻¹.

(Method of Measuring Gel Fraction)

One weight part of polyurethane film was placed in wire mesh, immersed in 100 weight parts of tetrahydrofuran (THF), and extracted at 70° C. for 3 hours. The wire mesh was removed. The film was washed by pouring 100 weight parts of fresh THF and vacuum dried for 3 hours at 140° C. The gel fraction was calculated as: (weight of polyurethane film after extraction/weight of polyurethane film before extraction)×100 (%). The gel fraction is given in Table 3.

With the exception that the type B polyurethane resin solution in Example 2-1 was changed from B-1 to the resin solution of B-11, the same operations were conducted. When the various components were dissolved in cyclohexanone, the polyurethane solution gelled in about 1 to 2 minutes. When, 0.5 to 1 minute after dissolution, the solution was used to coat a film by the same operation as in Example 2-1, the film foamed contained small gelled portions.

Based on the above results, the addition of an acid prior to the curing reaction with polyisocyanate was determined to be desirable for the polyurethane resin obtained by conducting the Michael addition reaction in the presence of a base.

### Examples 2-2 to 2-57

With the exceptions that the type of type B polyurethane resin solution, the type of polyisocyanate, and the quantity blended were changed as indicated in Table 3, polyurethane films were obtained by the same method as in Example 2-1.

Measurement of uncrosslinked polyisocyanate by the method set forth above detected none. Measurement of the gel fraction by the method set forth above gave the values shown in Table 3.

### Comparative Example 2-1

With the exception that the resin solution employed was changed to the resin solution of polyurethane A-1, a film was fabricated and uncrosslinked polyisocyanate was measured by the same methods as set forth above. As a result, the presence of equal to or more than 5 percent of residual polyisocyanate was confirmed. Thus, additional annealing was conducted under conditions of 100° C. for 2 days. When the sample subjected to the additional annealing was measured for uncrosslinked polyisocyanate by the method set forth above, none was found.

The gel fraction of the film obtained following the additional annealing was measured by the method set forth above, revealing a gel fraction of 86 percent.

### Comparative Examples 2-2 to 2-13

With the exception that the type of type A polyurethane resin solution and the quantity of polyisocyanate blended were changed as indicated in Table 3, polyurethane films were obtained by the same method as in Comparative Example 2-1. Measurement of the gel fraction following additional annealing gave the values shown in Table 3.

TABLE 3

| | | Quantity of | | Quantity of | |
|---|---|---|---|---|---|
| | | polyurethane | | isocyanate | |
| | Type of | blended | Type of | blended | Gel fraction |
| | polyurethane | (weight part) | polyurethane | (weight part) | (percent) |
| Ex. 2-1 | B-1 | 1 | 1 | 0.30 | 96 |
| Ex. 2-2 | B-1 | 1 | 1 | 0.075 | 89 |
| Ex. 2-3 | B-2 | 1 | 1 | 0.30 | 96 |
| Ex. 2-4 | B-3 | 1 | 1 | 0.30 | 95 |
| Ex. 2-5 | B-4 | 1 | 1 | 0.30 | 95 |
| Ex. 2-6 | B-4 | 1 | 1 | 0.15 | 93 |
| Ex. 2-7 | B-4 | 1 | 1 | 0.075 | 89 |
| Ex. 2-8 | B-5 | 1 | 1 | 0.30 | 96 |
| Ex. 2-9 | B-6 | 1 | 1 | 0.30 | 95 |
| Ex. 2-10 | B-7 | 1 | 1 | 0.30 | 97 |
| Ex. 2-11 | B-7 | 1 | 1 | 0.15 | 93 |
| Ex. 2-12 | B-7 | 1 | 1 | 0.075 | 89 |
| Ex. 2-13 | B-8 | 1 | 1 | 0.30 | 96 |
| Ex. 2-14 | B-8 | 1 | 1 | 0.15 | 93 |
| Ex. 2-15 | B-8 | 1 | 1 | 0.075 | 89 |
| Ex. 2-16 | B-9 | 1 | 1 | 0.15 | 89 |
| Ex. 2-17 | B-10 | 1 | 1 | 0.15 | 89 |
| Ex. 2-18 | B-1 | 1 | 1 | 0.15 | 93 |
| Ex. 2-19 | B-2 | 1 | 2 | 0.15 | 96 |
| Ex. 2-20 | B-3 | 1 | 3 | 0.15 | 96 |
| Ex. 2-21 | B-4 | 1 | 4 | 0.15 | 96 |
| Ex. 2-22 | B-5 | 1 | 5 | 0.15 | 95 |
| Ex. 2-23 | B-6 | 1 | 6 | 0.15 | 95 |
| Ex. 2-24 | B-7 | 1 | 7 | 0.15 | 95 |
| Ex. 2-25 | B-8 | 1 | 8 | 0.15 | 95 |
| Ex. 2-26 | B-9 | 1 | 9 | 0.15 | 95 |
| Ex. 2-27 | B-10 | 1 | 10 | 0.15 | 95 |
| Ex. 2-28 | B-21 | 1 | 1 | 0.15 | 96 |
| Ex. 2-29 | B-22 | 1 | 1 | 0.15 | 95 |
| Ex. 2-30 | B-23 | 1 | 1 | 0.15 | 94 |
| Ex. 2-31 | B-24 | 1 | 1 | 0.15 | 96 |
| Ex. 2-32 | B-26 | 1 | 1 | 0.15 | 95 |
| Ex. 2-33 | B-27 | 1 | 1 | 0.15 | 93 |
| Ex. 2-34 | B-28 | 1 | 1 | 0.15 | 96 |
| Ex. 2-35 | B-29 | 1 | 1 | 0.15 | 96 |
| Ex. 2-36 | B-30 | 1 | 1 | 0.15 | 96 |
| Ex. 2-37 | B-31 | 1 | 1 | 0.15 | 96 |
| Ex. 2-38 | B-32 | 1 | 1 | 0.15 | 93 |
| Ex. 2-39 | B-33 | 1 | 1 | 0.15 | 96 |
| Ex. 2-40 | B-34 | 1 | 1 | 0.15 | 95 |
| Ex. 2-41 | B-35 | 1 | 1 | 0.15 | 96 |
| Ex. 2-42 | B-36 | 1 | 1 | 0.15 | 92 |
| Ex. 2-43 | B-37 | 1 | 1 | 0.15 | 96 |
| Ex. 2-44 | B-38 | 1 | 1 | 0.15 | 95 |
| Ex. 2-45 | B-39 | 1 | 1 | 0.15 | 95 |
| Ex. 2-46 | B-40 | 1 | 1 | 0.15 | 90 |
| Ex. 2-47 | B-41 | 1 | 1 | 0.15 | 95 |
| Ex. 2-48 | B-42 | 1 | 1 | 0.15 | 95 |
| Ex. 2-49 | B-43 | 1 | 1 | 0.15 | 96 |
| Ex. 2-50 | B-44 | 1 | 1 | 0.15 | 95 |
| Ex. 2-51 | B-45 | 1 | 1 | 0.15 | 92 |
| Ex. 2-52 | B-46 | 1 | 1 | 0.15 | 95 |
| Ex. 2-53 | B-47 | 1 | 1 | 0.15 | 95 |
| Ex. 2-54 | B-48 | 1 | 1 | 0.15 | 89 |
| Ex. 2-55 | B-49 | 1 | 1 | 0.15 | 90 |
| Ex. 2-56 | B-50 | 1 | 1 | 0.15 | 90 |
| Ex. 2-57 | B-51 | 1 | 1 | 0.15 | 89 |
| Comp. Ex. 2-1 | A-1 | 1 | 1 | 0.30 | 86 |
| Comp. Ex. 2-2 | A-1 | 1 | 1 | 0.15 | 75 |
| Comp. Ex. 2-3 | A-2 | 1 | 1 | 0.30 | 86 |
| Comp. Ex. 2-4 | A-3 | 1 | 1 | 0.30 | 86 |
| Comp. Ex. 2-5 | A-4 | 1 | 1 | 0.30 | 86 |
| Comp. Ex. 2-6 | A-5 | 1 | 1 | 0.15 | 85 |
| Comp. Ex. 2-7 | A-6 | 1 | 1 | 0.15 | 85 |
| Comp. Ex. 2-8 | A-7 | 1 | 1 | 0.15 | 65 |
| Comp. Ex. 2-9 | A-8 | 1 | 1 | 0.15 | 67 |
| Comp. Ex. 2-10 | A-9 | 1 | 1 | 0.15 | 68 |
| Comp. Ex. 2-11 | A-10 | 1 | 1 | 0.15 | 70 |
| Comp. Ex. 2-12 | A-11 | 1 | 1 | 0.15 | 67 |
| Comp. Ex. 2-13 | A-12 | 1 | 1 | 0.15 | 67 |

Types of polyisocyanate (The types of polyisocyanate mentioned further below are also identical to those given below.)
1: Coronate 3041 made by Nippon Polyurethane Industry Co., Ltd.
2: Burnock D800 made by DIC
3: Millionate MT (MDI) made by Nippon Polyurethane Industry Co., Ltd.
4: 1,2-Phenylene diisocyanate made by Tokyo Chemical Industry Co., Ltd.
5: 1,5-Naphthalene diisocyanate made by Tokyo Chemical Industry Co., Ltd.
6: m-Xylylene diisocyanate made by Tokyo Chemical Industry Co., Ltd.
7: Isophorone diisocyanate made by Tokyo Chemical Industry Co., Ltd.
8: 2,4-Tolylene diisocyanate made by Tokyo Chemical Industry Co., Ltd.
9: 1,3-Bisisocyanatomethylcyclohexane diisocyanate made by Tokyo Chemical Industry Co., Ltd.
10: Hexamethylene diisocyanate made by Tokyo Chemical Industry Co., Ltd.

The gel fraction can be improved by (i) reacting the polyisocyanate with the hydroxyl groups contained in the polyurethane to form a crosslinked structure, and (2) incorporating polyurethane into the network structure formed by crosslinking of polyisocyanates. The higher the gel fraction, the greater the strength of the coating film To greatly increase the gel fraction, it is effective to increase the gel fraction by (i).

A comparison of those Examples and Comparative Examples differing only in that the polyurethane employed was type B or type A that was employed for synthesizing the type B reveals that Examples exhibited a higher gel fraction than the corresponding Comparative Examples. On that basis, the polyurethane according to an aspect of the present invention was found to have good reactivity (a good crosslinking property) with polyisocyanate.

Further, the use of a smaller quantity of polyisocyanate produced a higher gel fraction in Examples than in Comparative Examples. Thus, the polyurethane according to an aspect of the present invention was determined to exhibit high curability with just a small quantity of curing agent.

### 3. Examples and Comparative Examples Relating to Polyurethane Coating Films (a Comparison of Breaking Stress and the Rate of Increase in Breaking Stress)

### Example 3-1

The method set forth above was used to measure the solid fraction contained in the resin solution of polyurethane B-25, a quantity equivalent to one weight part of solid fraction was weighed out, and this quantity was cooled to equal to or lower than 10° C. A 0.3 weight part solution (0.15 weight part solid fraction, 0.075 weight part toluene, 0.075 weight part methyl ethyl ketone (2-butanone)) of polyisocyanate 1 (Coronate 3041, made by Nippon Polyurethane Industry Co., Ltd.) was added, after which cyclohexanone was added and dissolution was conducted to achieve a solid fraction of 22 weight percent.

The coating composition prepared by the above method was coated with a doctor blade having a gap of 300 μm on a base film (TORELINA (registered trademark) Film 3000, made by Toray Corp.) and vacuum dried under conditions of 140° C. for 30 minutes. The dry film obtained was cooled to room temperature and then annealed under conditions of 100° C. for 2 days. The annealed film obtained was cooled to room temperature and peeled off the base film, yielding a polyurethane film.

Separately from the above, a reference polyurethane film was prepared by the same method as set forth above with the exception that the 0.30 weight part of polyisocyanate 1 was not added.

The breaking stress and rate of increase in breaking stress of the films obtained were measured by the methods set forth below.

(Method of Measuring Breaking Stress)

The films obtained were cut to a width of 6.35 mm and a distance between chucks of 50 mm. The chuck distance of a Strograph V1-C made by Toyoseiki was set to 50 mm and the test speed to 50 mm/minute. The load (kgf) when the film broke was adopted as the breaking load. The value obtained by dividing the breaking load by the film cross-section (μm²) and multiplying the result by 9.8 was adopted as the breaking stress (MPa).

The breaking stress of the polyurethane film in the present Example was 78 MPa. The greater the breaking stress, the greater the strength of the coating film and the better its durability.

(Rate of Increase in Breaking Stress)

The value obtained by calculating [(breaking stress of polyurethane film of the Example)−(breaking stress of reference polyurethane film)]/(breaking stress of polyurethane film of the Example) was adopted as the rate (percent) of increase in the breaking stress.

The rate of increase in the breaking stress in the present Example was 41 percent. The rate of increase in the breaking stress shows the rate of increase in the coating strength due to crosslinking with the polyisocyanate. The greater this value, the greater the coating strength-enhancing effect of the curing reaction of the polyurethane and the polyisocyanate.

### Examples 3-2 to 3-53

With the exceptions that the type of type B polyurethane resin solution and the type and quantity of polyisocyanate blended were changed as indicated in Table 4, the same methods were used as in Example 3-1 to prepare Example polyurethane films and a reference polyurethane film, and to measure the breaking stress and rate of increase in the breaking stress. The results are given in Table 4.

TABLE 4

| | | | Quantity of | | Rate of increase |
|---|---|---|---|---|---|
| | | | polyisocyanate | Breaking | in the breaking |
| | Type B | | blended | stress | stress |
| | polyurethane | Polyisocyanate | [weight part] | [MPa] | [percent] |
| Ex. 3-1 | B-25 | 1 | 15.0 | 78 | 41 |
| Ex. 3-2 | B-26 | 1 | 15.0 | 80 | 34 |
| Ex. 3-3 | B-27 | 1 | 15.0 | 80 | 34 |
| Ex. 3-4 | B-28 | 1 | 7.5 | 78 | 11 |
| Ex. 3-5 | B-28 | 1 | 15.0 | 82 | 16 |
| Ex. 3-6 | B-29 | 1 | 7.5 | 78 | 11 |
| Ex. 3-7 | B-29 | 1 | 15.0 | 77 | 10 |
| Ex. 3-8 | B-30 | 1 | 3.8 | 78 | 11 |
| Ex. 3-9 | B-30 | 1 | 7.5 | 85 | 21 |
| Ex. 3-10 | B-30 | 1 | 15.0 | 85 | 21 |
| Ex. 3-11 | B-30 | 1 | 30.0 | 105 | 49 |
| Ex. 3-12 | B-30 | 2 | 7.5 | 85 | 22 |
| Ex. 3-13 | B-30 | 2 | 15.0 | 100 | 43 |
| Ex. 3-14 | B-30 | 3 | 3.8 | 80 | 14 |
| Ex. 3-15 | B-30 | 3 | 7.5 | 82 | 17 |
| Ex. 3-16 | B-30 | 3 | 15.0 | 88 | 26 |
| Ex. 3-17 | B-30 | 4 | 7.5 | 82 | 16 |
| Ex. 3-18 | B-30 | 4 | 15.0 | 98 | 40 |
| Ex. 3-19 | B-30 | 5 | 7.5 | 82 | 17 |
| Ex. 3-20 | B-30 | 5 | 15.0 | 83 | 19 |
| Ex. 3-21 | B-30 | 6 | 7.5 | 83 | 19 |
| Ex. 3-22 | B-30 | 6 | 15.0 | 85 | 21 |
| Ex. 3-23 | B-30 | 7 | 7.5 | 85 | 21 |
| Ex. 3-24 | B-30 | 7 | 15.0 | 89 | 27 |
| Ex. 3-25 | B-30 | 8 | 7.5 | 90 | 29 |
| Ex. 3-26 | B-30 | 8 | 15.0 | 95 | 36 |
| Ex. 3-27 | B-30 | 9 | 7.5 | 82 | 17 |
| Ex. 3-28 | B-30 | 9 | 15.0 | 83 | 19 |
| Ex. 3-29 | B-34 | 1 | 3.8 | 78 | 12 |
| Ex. 3-30 | B-34 | 1 | 7.5 | 84 | 21 |
| Ex. 3-31 | B-34 | 1 | 15.0 | 88 | 26 |
| Ex. 3-32 | B-34 | 2 | 7.5 | 82 | 17 |
| Ex. 3-33 | B-34 | 2 | 15.0 | 92 | 31 |
| Ex. 3-34 | B-35 | 1 | 3.8 | 83 | 12 |
| Ex. 3-35 | B-35 | 1 | 7.5 | 82 | 11 |
| Ex. 3-36 | B-35 | 1 | 15.0 | 93 | 26 |
| Ex. 3-37 | B-35 | 2 | 7.5 | 85 | 15 |
| Ex. 3-38 | B-35 | 2 | 15.0 | 104 | 41 |
| Ex. 3-39 | B-35 | 2 | 7.5 | 82 | 11 |
| Ex. 3-40 | B-35 | 3 | 7.5 | 85 | 15 |
| Ex. 3-41 | B-35 | 3 | 15.0 | 88 | 19 |
| Ex. 3-42 | B-35 | 5 | 7.5 | 86 | 16 |
| Ex. 3-43 | B-35 | 5 | 15.0 | 98 | 32 |
| Ex. 3-44 | B-36 | 1 | 3.8 | 83 | 10 |
| Ex. 3-45 | B-36 | 1 | 7.5 | 83 | 11 |
| Ex. 3-46 | B-36 | 1 | 15.0 | 82 | 10 |
| Ex. 3-47 | B-37 | 1 | 7.5 | 77 | 10 |
| Ex. 3-48 | B-37 | 1 | 15.0 | 82 | 18 |
| Ex. 3-49 | B-38 | 1 | 7.5 | 87 | 22 |
| Ex. 3-50 | B-38 | 1 | 15.0 | 85 | 19 |
| Ex. 3-51 | B-38 | 2 | 15.0 | 97 | 36 |
| Ex. 3-52 | B-47 | 1 | 15.0 | 90 | 27 |
| Ex. 3-53 | B-49 | 1 | 15.0 | 93 | 27 |

### Examples 3-54 to 3-60

With the exceptions that the type of type B polyurethane resin solution and the type and quantity of polyisocyanate blended were changed as indicated in Table 5, the same methods were used as in Example 3-1 to prepare Example polyurethane films and a reference polyurethane film, and to measure the breaking stress and rate of increase in the breaking stress. The results are given in Table 5.

TABLE 5

| | | | | | Rate of |
|---|---|---|---|---|---|
| | | | | | increase |
| | | | | | in the |
| | | | Quantity of | Breaking | breaking |
| | Type B | | polyisocyanate blended | stress | stress |
| | polyurethane | Polyisocyanate | [weight part] | [MPa] | [percent] |
| Ex. 3-54 | B-4 | 1 | 3.8 | 73 | −3 |
| Ex. 3-55 | B-4 | 1 | 7.5 | 73 | −3 |
| Ex. 3-56 | B-4 | 1 | 15.0 | 74 | −1 |
| Ex. 3-57 | B-5 | 1 | 7.5 | 74 | 1 |
| Ex. 3-58 | B-5 | 1 | 15.0 | 75 | 3 |
| Ex. 3-59 | B-8 | 1 | 7.5 | 75 | 3 |
| Ex. 3-60 | B-30 | 10 | 15.0 | 65 | −7 |

The Example polyurethane films shown in Table 4 were prepared using type B polyurethane resin with a polyurethane backbone in the form of polyester polyurethane

By contrast, the polyurethane films of Examples 3-54 to 3-59 in Table 5 are films prepared using B type polyurethane resin with a polyurethane backbone in the form of polyether polyurethane.

The polyurethane film of Example 3-60 in Table 5 is a film prepared using a type B polyurethane resin with a polyurethane backbone in the form of polyester polyurethane. The polyisocyanate employed was polyisocyanate 10, which did not have a cyclic structure.

A comparison of the results shown in Tables 4 and 5 confirms that the polyurethane according to an aspect of the present invention could provide an even stronger coating film by (1) being a polyester polyurethane and (2) by being employed in combination with a polyisocyanate having a cyclic structure.

### 4. Examples and Comparative Examples Relating to Particulate Magnetic Recording Media

In the following description, the word “part” indicates weight part.

### Example 4-1

(1) Preparation of Magnetic Layer Coating Liquid
Ferromagnetic hexagonal barium ferrite powder: 100 parts

Composition: Fe/Co=100/25

Hc: 195 kA/m (approximately 2,450 Oe)

Specific surface area by BET method: 65 m²/g

Surface was treated with Al₂O₃, SiO₂, Y₂O₃.

Particle size (average major axis length): 35 mm

Acicular ratio: 5

σs: 110 A·m²/kg (approximately 110 emu/g)
Dispersing agent: oleic acid: 1.5 parts
Binder: type B polyurethane (B-30) solution: 14.3 parts (converted to solid fraction)
Methyl ethyl ketone: 327 parts
Cyclohexanone: 228 parts
Toluene: 11 parts

With regard to the above coating materials, the various components were dispersed for 20 hours in a sand mill using zirconia beads. To the dispersions obtained were added:

α-Al₂O₃ Mohs hardness 9 (average particle diameter 0.1 μm): 7.3 parts

Carbon black 1 (average particle diameter 80 nm): 0.5 part

Butyl stearate: 1.5 parts

Stearic acid: 0.5 part

Stearic acid amide: 0.3 part

Polyisocyanate 1 (Coronate 3041, made by Nippon Polyurethane Industry Co., Ltd.): 5 parts

The mixture was stirred for 20 minutes, ultrasonically processed, and filtered with a filter having a 1 μm average pore diameter to prepare a magnetic layer coating liquid.

(2) Preparation of Nonmagnetic Layer Coating Liquid
Nonmagnetic powder (α-Fe₂O₃ hematite): 100 parts

Major axis length: 0.15 μm

Specific surface area by BET method: 52 m²/g

pH: 6

Tap density: 0.8

DBP oil absorption capacity: 27 to 38 g/100 g

Surface treatment agent: Al₂O₃, SiO₂
Carbon black 2: 25 parts

Average primary particle diameter: 0.020 μm

DBP oil absorption capacity: 80 mL/100 g²

pH: 8.0

Specific surface area by BET method: 250 m²/g

Volatile content: 1.5 percent
Radiation-curable vinyl chloride copolymer obtained in Preparation Example I. below: 14.9 parts
Radiation-curable polyurethane resin obtained in Preparation Example II. below: 9.3 parts
Dispersing agent: Phenylphosphonic acid: 3.8 parts
Methyl ethyl ketone: 15 parts
Cyclohexanone: 90 parts

### Preparation Example I

A radiation-curable vinyl chloride resin was prepared by the method described in Japanese Unexamined Patent Publication (KOKAI) No. 2011-216179, paragraphs [0191] to [0194].

### Preparation Example II

A radiation-curable polyurethane resin was prepared by the method described in Japanese Unexamined Patent Publication (KOKAI) No. 2011-216179, paragraphs [0228] and [0229].

With regard to the above coating materials, the various components were kneaded in an open kneader and dispersed using a sand mill.

To the dispersions obtained were added:

Butyl stearate: 1.9 parts

Stearic acid: 1.9 parts

Stearic acid amide: 0.3 part

Methyl ethyl ketone: 170 parts

Cyclohexanone: 200 parts.

The mixture was then stirred and filtered with a filter having an average pore diameter of 1 μm to prepare a nonmagnetic layer coating liquid.

(3) Preparation of Backcoat Layer Coating Liquid

Carbon black 3 (average particle diameter 40 nm): 85 parts

Carbon black 4 (average particle diameter 100 nm): 3 parts

Nitrocellulose: 28 parts

Polyester resin (Vylon 500, made by Toyobo): 54 parts

Copper phthalocyanine dispersing agent: 2.5 parts

Polyurethane resin (Nipporan 2301, made by Nippon Polyurethane Industry Co., Ltd.): 0.5 part

Methyl isobutyl ketone: 0.3 part

Methyl ethyl ketone: 860 parts, and

Toluene: 240 parts

were prekneaded in a roll mill and then dispersed in a sand mill. Four parts of polyester resin (Vylon 500, made by Toyobo), 14 parts of polyisocyanate compound (Coronate 3041, made by Nippon Polyurethane Industry Co., Ltd.) and 5 parts of α-Al₂O₃ (made by Sumitomo Chemicals) were added and the mixture was stirred and filtered to prepare a backcoat layer coating liquid.

The above nonmagnetic layer coating liquid was coated in a quantity calculated to yield a film thickness of 1.5 μm upon drying on a 5 μm polyethylene naphthalate resin support and 50 kGy irradiated with radiation. Subsequently, the magnetic layer coating liquid was coated and dried to a thickness of 0.10 μm. The backcoat layer was then coated in a quantity calculated to yield a thickness upon drying of 0.5 μm on the opposite side from the magnetic layer.

A seven-stage calender comprised solely of metal rolls was then used to conduct calendering at a rate of 100 m/minute, a linear pressure of 350 kg/cm (343 kN/m), and a temperature of 80° C. The roll obtained was then heat treated for 48 hours at 50° C. and then slit to a ½ inch width to prepare a magnetic tape.

(Magnetic Tape Scratch Test)

The magnetic tape obtained was cut to a 20 cm length and run back and forth over an SUS rod 30,000 times under conditions of a 25° lapping angle and 100 g tension. The surface of the tape following passage over the rod was observed under a microscope. The level of scratching of the surface of the magnetic layer was then evaluated based on the following three-step scale:
3: No scratching observed on the surface of the coating film
2: Slight scratching observed on the surface of the coating film
1: Deep scratching observed on the surface of the coating film, with scraped magnetic surface components depositing on the coating film

### Examples 4-2 to 4-9, Comparative Examples 4-1 and 4-2

With the exception that the formulae of the various layer-forming coating liquids and the methods of fabricating the various layers were changed as indicated in Table 6, magnetic tapes were prepared and scratch tests were conducted by the same methods as in Example 4-1. The results are given in Table 6.

TABLE 6

| | | Ex. 4-1 | Ex. 4-2 | Ex. 4-3 | Ex. 4-4 | Ex. 4-5 | Ex. 4-6 | Ex. 4-7 | Ex. 4-8 | Ex. 4-9 |
|---|---|---|---|---|---|---|---|---|---|---|
| Magnetic layer | Quantity of ferromagnetic powder (part) | 100 | 100 | 100 | 100 | 100 | 100 | 100 | 100 | 100 |
| | Quantity of dispersing agent: oleic acid (part) | 1.5 | 1.5 | 1.5 | 1.5 | 1.5 | 1.5 | 1.5 | 1.5 | 1.5 |
| | Quantity of dispersing agent: naphthalenediol (part) | 0 | 0 | 0 | 0 | 0 | 6.3 | 6.3 | 6.3 | 6.3 |
| | Type of polyurethane | B-30 | B-30 | B-30 | B-30 | B-30 | B-33 | B-34 | B-33 | B-34 |
| | Quantity of polyurethane (part) | 14.3 | 10.0 | 4.3 | 10.0 | 4.3 | 10.0 | 4.0 | 4.0 | 4.0 |
| | Vinyl chloride resin (MR-104 made by Zeon Corp.) (part) | 0 | 4.27 | 10 | 4.27 | 10 | 4 | 10 | 10 | 10 |
| | Alumina | 7.3 | 7.3 | 7.3 | 7.3 | 7.3 | 6.0 | 6.0 | 6.0 | 6.0 |
| | Quantity of carbon black 1 (part) | 0.5 | 0.5 | 0.5 | 0.5 | 0.5 | | | | |
| | Methyl ethyl ketone solution containing 15 weight percent | | | | | | 2.3 | 2.3 | 2.3 | 2.3 |
| | colloidal silica (Fuso Chemical Co., Ltd.) (part) | | | | | | | | | |
| | Quantity of butyl stearate (part) | 1.5 | 1.5 | 1.5 | 1.5 | 1.5 | 6.0 | 6.0 | 6.0 | 6.0 |
| | Quantity of stearic acid (part) | 0.5 | 0.5 | 0.5 | 0.5 | 0.5 | 1.5 | 1.5 | 1.5 | 1.5 |
| | Quantity of stearic acid amide (part) | 0.3 | 0.3 | 0.3 | 0.3 | 0.3 | 0.3 | 0.3 | 0.3 | 0.3 |
| | Quantity of methyl ethyl ketone (part) | 327 | 327 | 327 | 327 | 327 | 291 | 291 | 291 | 291 |
| | Quantity of cyclohexanone (part) | 228 | 228 | 228 | 228 | 228 | 367 | 367 | 367 | 367 |
| | Quantity of toluene (part) | 11 | 11 | 11 | 11 | 11 | 1 | 1 | 1 | 1 |
| | Type of polyisocyanate | 1 | 1 | 1 | 2 | 2 | 1 | 1 | 1 | 1 |
| | Quantity of polyisocyanate (part) | 5 | 5 | 5 | 5 | 5 | 5 | 5 | 5 | 5 |
| | Dry film thickness (μm) | 0.10 | 0.10 | 0.10 | 0.10 | 0.10 | 0.10 | 0.10 | 0.10 | 0.10 |
| Nonmagnetic layer | Quantity of nonmagnetic powder (part) | 100 | 100 | 100 | 100 | 100 | 100 | 100 | | |
| | Quantity of carbon black 2 (part) | 25 | 25 | 25 | 25 | 25 | 25 | 25 | 100 | 100 |
| | Quantity of radiation-curable polyurethane resin (part) | 14.9 | 14.9 | 14.9 | 14.9 | 14.9 | 14.9 | 14.9 | 14.9 | 14.9 |
| | Quantity of radiation-curable vinyl chloride copolymer (part) 9.3 | 9.3 | 9.3 | 9.3 | 9.3 | 9.3 | 9.3 | 9.0 | 9.0 | |
| | Quantity of methyl ethyl ketone (part) | 185 | 185 | 185 | 185 | 185 | 350 | 350 | 350 | 350 |
| | Quantity of cyclohexanone (part) | 290 | 290 | 290 | 290 | 290 | 233 | 233 | 233 | 233 |
| | Quantity of dispersing agent Phenylphosphonic acid (part) | 3.8 | 3.8 | 3.8 | 3.8 | 3.8 | 3.8 | 3.8 | | |
| | Quantity of dispersing agent Di-tert-butylethylenediamine (part) | | | | | | | | 2.3 | 2.3 |
| | Quantity of butyl stearate (part) | 1.9 | 1.9 | 1.9 | 1.9 | 1.9 | 1.9 | 1.9 | 1.5 | 1.5 |
| | Quantity of stearic acid (part) | 1.9 | 1.9 | 1.9 | 1.9 | 1.9 | 1.9 | 1.9 | 1.5 | 1.5 |
| | Quantity of stearic acid amide (part) | 0.3 | 0.3 | 0.3 | 0.3 | 0.3 | 0.3 | 0.3 | 0.2 | 0.2 |
| | Exposure to radiation | Conducted | Conducted | Conducted | Conducted | Conducted | Conducted | Conducted | Not conducted | Not conducted |
| | Dry film thickness (μm) | 1.0 | 1.0 | 1.0 | 1.0 | 1.0 | 0.10 | 0.10 | 0.10 | 0.10 |
| Backcoat layer | Quantity of carbon black 3 (part) | 85 | 85 | 85 | 85 | 85 | 85 | 85 | 85 | 85 |
| | Quantity of carbon black 4 (part) | 3 | 3 | 3 | 3 | 3 | 3 | 3 | 3 | 3 |
| | Quantity of nitrocellulose (part) | 28 | 28 | 28 | 28 | 28 | 28 | 28 | 28 | 28 |
| | Quantity of polyester resin (part) | 58 | 58 | 58 | 58 | 58 | 58 | 58 | 58 | 58 |
| | Quantity of copper phthalocyanine dispersing agent (part) | 2.5 | 2.5 | 2.5 | 2.5 | 2.5 | 2.5 | 2.5 | 2.5 | 2.5 |
| | Quantity of polyurethane resin (part) | 0.5 | 0.5 | 0.5 | 0.5 | 0.5 | 0.5 | 0.5 | 0.5 | 0.5 |
| | Quantity of methyl isobutyl ketone (part) | 0.3 | 0.3 | 0.3 | 0.3 | 0.3 | 0.3 | 0.3 | 0.3 | 0.3 |
| | Quantity of methyl ethyl ketone (part) | 860 | 860 | 860 | 860 | 860 | 860 | 860 | 860 | 860 |
| | Quantity of toluene (part) | 240 | 240 | 240 | 240 | 240 | 240 | 240 | 240 | 240 |
| | Result of scratch test | 3 | 2 | 2 | 2 | 2 | 3 | 3 | 2 | 2 |

| | | Comp. Ex. 4-1 | Comp. Ex. 4-2 |
|---|---|---|---|
| Magnetic | Quantity of ferromagnetic powder (part) | 100 | 100 |
| layer | Quantity of dispersing agent: oleic acid (part) | 1.5 | 1.5 |
| | Quantity of dispersing agent: naphthalenediol (part) | 0 | 6.3 |
| | Type of polyurethane | A-8 | A-9 |
| | Quantity of polyurethane (part) | 4.3 | 4.0 |
| | Vinyl chloride resin (MR-104 made by Zeon Corp.) (part) | 10 | 10 |
| | Alumina | 7.3 | 6.0 |
| | Quantity of carbon black 1 (part) | 0.5 | |
| | Methyl ethyl ketone solution containing 15 weight percent colloidal | | 2.3 |
| | silica (Fuso Chemical Co., Ltd.) (part) | | |
| | Quantity of butyl stearate (part) | 1.5 | 6.0 |
| | Quantity of stearic acid (part) | 0.5 | 1.5 |
| | Quantity of stearic acid amide (part) | 0.3 | 0.3 |
| | Quantity of methyl ethyl ketone (part) | 327 | 291 |
| | Quantity of cyclohexanone (part) | 228 | 367 |
| | Quantity of toluene (part) | 11 | 1 |
| | Type of polyisocyanate | 1 | 1 |
| | Quantity of polyisocyanate (part) | 5 | 5 |
| | Dry film thickness (μm) | 0.10 | 0.10 |
| Nonmagnetic | Quantity of nonmagnetic powder (part) | 100 | |
| layer | Quantity of carbon black 2 (part) | 25 | 100 |
| | Quantity of radiation-curable polyurethane resin (part) | 14.9 | 14.9 |
| | Quantity of radiation-curable vinyl chloride copolymer (part) | 9.3 | 9.0 |
| | Quantity of methyl ethyl ketone (part) | 185 | 350 |
| | Quantity of cyclohexanone (part) | 290 | 233 |
| | Quantity of dispersing agent Phenylphosphonic acid (part) | 3.8 | |
| | Quantity of dispersing agent Di-tert-butylethylenediamine (part) | | 2.3 |
| | Quantity of butyl stearate (part) | 1.9 | 1.5 |
| | Quantity of stearic acid (part) | 1.9 | 1.5 |
| | Quantity of stearic acid amide (part) | 0.3 | 0.2 |
| | Exposure to radiation | Conducted | Conducted |
| | Dry film thickness (μm) | 1.0 | 0.10 |
| Backcoat | Quantity of carbon black 3 (part) | 85 | 85 |
| layer | Quantity of carbon black 4 (part) | 3 | 3 |
| | Quantity of nitrocellulose (part) | 28 | 28 |
| | Quantity of polyester resin (part) | 58 | 58 |
| | Quantity of copper phthalocyanine dispersing agent (part) | 2.5 | 2.5 |
| | Quantity of polyurethane resin (part) | 0.5 | 0.5 |
| | Quantity of methyl isobutyl ketone (part) | 0.3 | 0.3 |
| | Quantity of methyl ethyl ketone (part) | 860 | 860 |
| | Quantity of toluene (part) | 240 | 240 |
| | Result of scratch test | 1 | 1 |

Based on a comparison of Examples and Comparative Examples in Table 6, the polyurethane resin according to an aspect of the present invention was determined to contribute to enhancing the durability of the magnetic recording media of the various formulae and preparation methods.

The present invention is useful in the field of manufacturing polyurethane resin, and in the field of manufacturing various products to which polyurethane coating films are applied, such as particulate magnetic recording media.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A method of manufacturing a polyurethane resin, which comprises subjecting a (meth)acryloyl(oxy) group-containing polyurethane resin and a hydroxyl group-containing thiol to a Michael addition reaction in a solvent to provide a hydroxyl group-containing polyurethane resin.

2. The method of manufacturing a polyurethane resin according to claim 1, wherein the Michael addition reaction is conducted in a solvent which comprises a base.

3. The method of manufacturing a polyurethane resin according to claim 2, which further comprises adding an equivalent or greater quantity of an acid to the base following the Michael addition reaction.

4. The method of manufacturing a polyurethane resin according to claim 3, wherein the acid is an organic acid.

5. The method of manufacturing polyurethane resin according to claim 2, wherein the base is an organic base.

6. The method of manufacturing a polyurethane resin according to claim 1, wherein the (meth)acryloyl(oxy) group-containing polyurethane resin comprises at least one substituent selected from the group consisting of a sulfonic acid group and a sulfonate group.

7. The method of manufacturing a polyurethane resin according to claim 1, wherein the (meth)acryloyl(oxy) group-containing polyurethane resin is polyurethane resin that has been provided through an urethane reaction with a polyol component in the form of a (meth)acryloyl(oxy) group-containing diol.

8. The method of manufacturing a polyurethane resin according to claim 1, wherein the hydroxyl group-containing polyurethane resin that has been provided has a hydroxyl group equivalent specified in equation (1) below ranging from 5 to 200:
hydroxyl group equivalent=hydroxyl group value [millimole/kg]×weight average molecular weight Mw/1,000,000 (1).

9. The method of manufacturing a polyurethane resin according to claim 1, wherein the solvent comprises equal to or more than 60 weight percent of a ketone solvent.

10. A polyurethane resin provided by the method according to claim 1.

11. A particulate magnetic recording medium, which comprises a layer comprising the polyurethane resin according to claim 10 and/or a reaction product thereof.

12. The particulate magnetic recording medium according to claim 11, wherein the reaction product is a reaction product of a curing reaction of the polyurethane resin and a polyisocyanate.

13. The particulate magnetic recording medium according to claim 12, wherein the polyisocyanate is a polyisocyanate comprising a cyclic structure.

14. The particulate magnetic recording medium according to claim 11, wherein the layer is a magnetic layer comprising a ferromagnetic powder.

15. The particulate magnetic recording medium according to claim 12, wherein the layer is a magnetic layer comprising a ferromagnetic powder.

16. The particulate magnetic recording medium according to claim 13, wherein the layer is a magnetic layer comprising a ferromagnetic powder.

17. A coating-forming composition, which comprising the polyurethane resin according to claim 10 and a polyisocyanate.

18. The coating-forming composition according to claim 17, wherein the polyisocyanate is a polyisocyanate comprising a cyclic structure.

19. A polyurethane coating film, which has been formed by subjecting the coating-forming composition according to claim 17 to a curing treatment.

20. A polyurethane coating film, which has been formed by subjecting the coating-forming composition according to claim 18 to a curing treatment.
